(19) United States
(12) Patent Application Publication
(10) Pub. No.: US 2003/0030724 A1
(43) Pub. Date: Feb. 13, 2003

(54) Park-assisting apparatus

(75) Inventor: Shinichi Okamoto, Shizuoka (JP)

Correspondence Address: ARMSTRONG,WESTERMAN & HATTORI, LLP, 1725 K STREET, NW., SUITE 1000, WASHINGTON, DC, 20006, US

(73) Assignee: Yazaki Corporation, Tokyo (JP)

(21) Appl. No.: 10/189,564

(22) Filed: Jul. 8, 2002

(30) Foreign Application Priority Data
Aug. 8, 2001 (JP) 2001-241385

(51) Int. Cl. H04N 7/18; H04N 9/47

(52) U.S. Cl. 348/148; 340/435; 340/932.2

(57) ABSTRACT

Assisting a vehicle driver to place a vehicle securely to a parking space by driving a vehicle backward to maintain the maximum steering angle set at a position to start driving a vehicle backward, a park-assisting apparatus includes a display device 3 for displaying a predetermined rear area view of a vehicle; an image of intended course storing device 4 for storing beforehand an intended course to be driven in the predetermined rear area view when the vehicle is driven backward with the maximum steering angle; and a superimposing display device 2 for displaying the intended course by superimposing on the rear area view of the vehicle taken by the image pick-up device 1 in the display device 3.

### BACKGROUND OF THE INVENTION

1. Field of the Invention

This invention relates to a park-assisting apparatus, which assists a vehicle driver in parking a vehicle to indicate a driving course information during parallel parking, garaging or driving a vehicle backward.

2. Description of the Related Art

A parking auxiliary apparatus, which is disclosed in J.P.A. 2000-79860, exists as such a park-assisting apparatus by prior art. Indicating a intended driving course by a steering angle on a display in a dashboard during parking a vehicle; setting a window of a required area, in which a white line of a parking space in the vicinity of the intended driving course can be sensed, on the display, based on the indicated position of the intended driving course; sensing the white line on the display; sensing position and direction of the white line when the white line is on the window; and analyzing a parking space with feature and geometrical location of the white line, the parking auxiliary apparatus advises a vehicle driver on parking operation.

Objects to be Solved

The park-assisting apparatus by prior art requires a high speed CPU for processing complicated images while sensing the white line of a parking space in a camera view area, as mentioned above. Therefore, cost of the park-assisting apparatus would be very expensive.

Further, the park-assisting apparatus can not guide a vehicle driver to place a vehicle into a parking space without a white line on a ground of the parking space for showing a parking space. Therefore, the park-assisting apparatus is not for general use because the apparatus is limited on a usable place and not fit for garaging or driving a vehicle backward to park in a grassland parking space.

A vehicle driver is required to have certain skill for driving a vehicle backward while operating a steering wheel with watching a display and listening to message voice to keep in the white line. It may be difficult for a newly-licensed driver.

To overcome the above drawback of prior art, one object of this invention is to provide a park-assisting apparatus which can assist a vehicle driver to place a vehicle securely into a parking space only by driving a vehicle backward without operating a steering wheel to maintain the maximum steering angle being set at a starting position of driving a vehicle backward.

### SUMMARY OF THE INVENTION

How to Attain the Object

In order to attain the objects, a park-assisting apparatus according to this invention, as shown in a basic block diagram of FIG. 1, includes a display device 3 for displaying an image of a predetermined rear area view of a vehicle, a relative position of which is fixed against the vehicle; an image of intended course storing device 4 for storing beforehand an image of an intended course in order to display the image of intended course of the vehicle by superimposing on the rear area view of the display device 3, the intended course being a course to be driven in the predetermined rear area view of the vehicle corresponding to the vehicle in a current position when the vehicle is driven backward with the maximum steering angle; an image pick-up device 1 for taking a picture of the rear area view of the vehicle; and a superimposing display device 2 for displaying the image of the intended course, which is stored in the image of intended course, storing device 4, by superimposing on the image of the rear area view of the vehicle being taken by the image pick-up device 1 in the display device 3, upon receiving a display command from outside.

According to the park-assisting apparatus as mentioned above, when parking a vehicle to drive the vehicle into a parking space by driving the vehicle backward, after displaying a intended course of the vehicle, which is a course to be driven in the predetermined rear area view of the vehicle corresponding to the vehicle in the current position when driving the vehicle backward with the maximum steering angle, to superimpose on the image of the rear area view of the vehicle in the display device, driving the vehicle to adjust a gateway of the parking space in the image of the rear area view of the vehicle to a required passing position in the intended course, driving the vehicle backward to maintain the maximum steering angle when ascertaining coincidence of the gateway of the parking space and the vehicle passing position in the displayed image, the vehicle can be driven securely into the parking space along the intended course.

Furthermore, in the park-assisting apparatus according to this invention, the image of intended course storing device 4 stores images of intended courses of the maximum steering angle to the right and the maximum steering angle to the left and outputs one of the stored images to the superimposing display device 2 selectively by control of a display control device 5 in compliance with operating image switching devices S1 and S2.

According to the park-assisting apparatus as mentioned above, if right or left direction is selected by operating the image switching device S1, S2, the display control device 5 outputs an image of intended course of the maximum steering angle to the right or the maximum steering angle to the left in the image of intended course storing device 4 to the superimposing display device 2 selectively in compliance with a selected direction, when driving the vehicle into the parking space by driving the vehicle backward with maintaining the maximum steering angle to the right or the maximum steering angle to the left. Therefore, a vehicle can be driven to a parking space to be turned to any of both directions without operating steering wheel during driving the vehicle backward so that a very flexible park-assisting apparatus can be provided.

The above and other objects and features of this invention will become more apparent from the following description taken in conjunction with the accompanying drawings.

### BRIEF DESCRIPTION OF THE DRAWINGS

FIG. 1 is a basic block diagram of a park-assisting apparatus according to this invention;

FIG. 2 is a block diagram of an embodiment of a park-assisting apparatus according to this invention;

FIG. 3 is a flowchart for explaining actions of an embodiment of a park-assisting apparatus according to this invention; and

FIG. 4A, 4B, 4C, 4D and 4E are drafts of screens for explaining a driving course of a vehicle during parking.

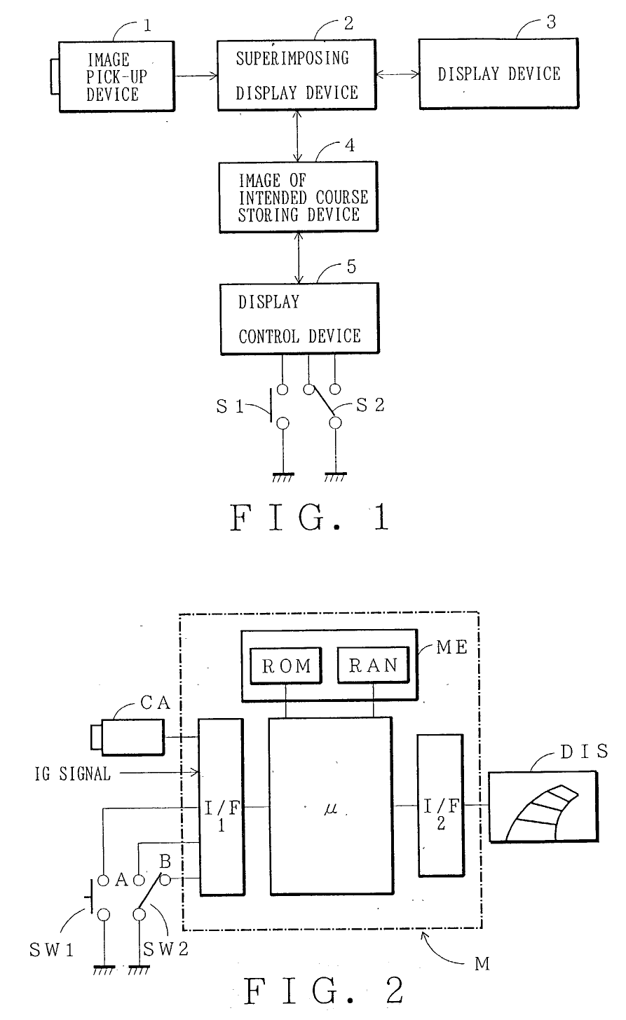

### DESCRIPTION OF THE PREFERRED EMBODIMENT

A park-assisting apparatus according to a first embodiment of this invention will now be described with reference to drawings. FIG. 2 shows an embodiment of a park-assisting apparatus, according to this invention. The park-assisting apparatus includes a camera CA, such as a CCD camera, being mounted at a rear portion of a vehicle for taking a picture of the rear area view of the vehicle, a microcomputer M for processing an image signal to be outputted by the camera CA and outputting a display image datum to an image display device DIS being mounted on a panel of a center console in the vehicle, a rear indicating switch SW1 being mounted in the vicinity of the center console for instructing the microcomputer M to indicate the image of the rear area view of the vehicle in the image display device DIS, and a course indicating switch SW2 being mounted in the vicinity of the center console for instructing the microcomputer M to indicate an image of an intended driving course (described the intended driving course after) at turning to a required direction of the vehicle to superimpose on the image of the rear area view of the vehicle in the image display device DIS.

The camera CA may be mounted at upper area of the center of a license plate (number-plate) on the vehicle rear to tilt an optical axis of the camera CA down by approximately 30 degree, for example. Therefore, the camera CA has a view angle of 140 degree in a right-left direction, depending on a lens of the camera CA and can sense to 8 meters area in a rear direction.

The microcomputer M includes a memory ME having a ROM for storing a program for processing input/output signals and processing input image signals for display image data, a program for processing the display image data to display images in the image display device DIS, a program for processing to display an image of the rear area view of the vehicle and the image of the intended course by superimposing, and data of the image of intended course being generated beforehand, and a RAM for storing processed data or input data temporarily; an input interface I/F1 for inputting respective switch signals, an ignition (IG) signal and image signals of the camera CA to a microprocessor μ; and an output interface I/F2 for outputting image data of the rear area view of the vehicle and the intended course by the microprocessor μ to the image display device DIS.

When an ON switch signal of the rear indicating switch SW1 is inputted to the microcomputer M, the microcomputer M makes the image display device DIS display an image of the rear area view of the vehicle being taken by the camera CA. The microcomputer M reads an image datum of the intended course of the vehicle with the maximum steering angle to the right when turning the course indicating switch SW2 to A side or with the maximum steering angle to the left when turning the course indicating switch SW2 to B side, out from the ROM, and makes the image display device DIS display the image of the intended course to superimpose on the image of the rear area view of the vehicle on a screen. When the IG signal is turned off to be brought by engine stop, the microcomputer M makes the image display device DIS stop displaying images.

The image datum of the intended course, mentioned above, is for an intended course on which the vehicle will pass in the predetermined area of the screen, corresponding to the vehicle in the current position, when the vehicle is driven backward with the maximum steering angle, and to display the image fixedly in the screen regardless of changing image of the rear area view of the vehicle in the screen.

An example of calculating an image datum of an intended course is disclosed in J.P.A. S64-14700 so that a method of calculating the image datum is omitted herein.

Before explaining action of this invention, outline of this invention will be explained herein.

This invention is to display an image of an intended course, which is a driving datum for a vehicle driver to move a vehicle to a suitable position for starting to drive the vehicle backward when parking into a parking space of the driver's preference by driving the vehicle backward with the maximum steering angle from a bypass, in a screen.

The driver moves the vehicle to adjust a gateway of a parking space, displayed in the image of the rear area view of the vehicle, to a final passing position of the vehicle, which may drives finally through the position, in the image of intended course displayed fixedly in a predetermined area of the screen regardless of a driving direction of the vehicle.

Driving the vehicle backward with maintaining the maximum steering angle at a position where the gate of the parking space coincides with the final passing position, the vehicle can drive into the parking space along the intended course.

Thus, a driver can drive a vehicle into a parking space without an operation of a steering wheel during driving the vehicle backward.

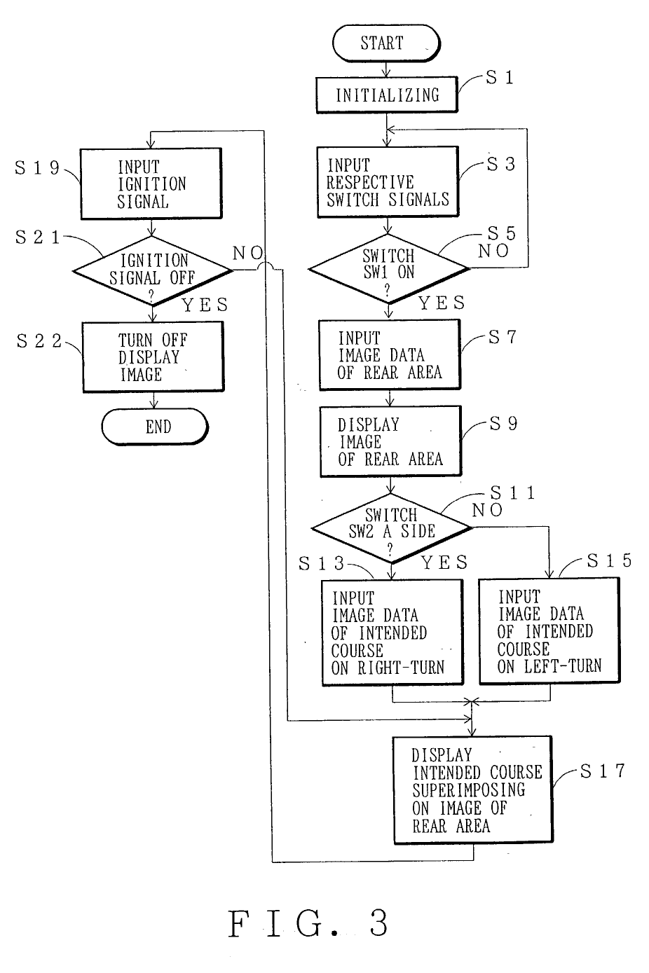

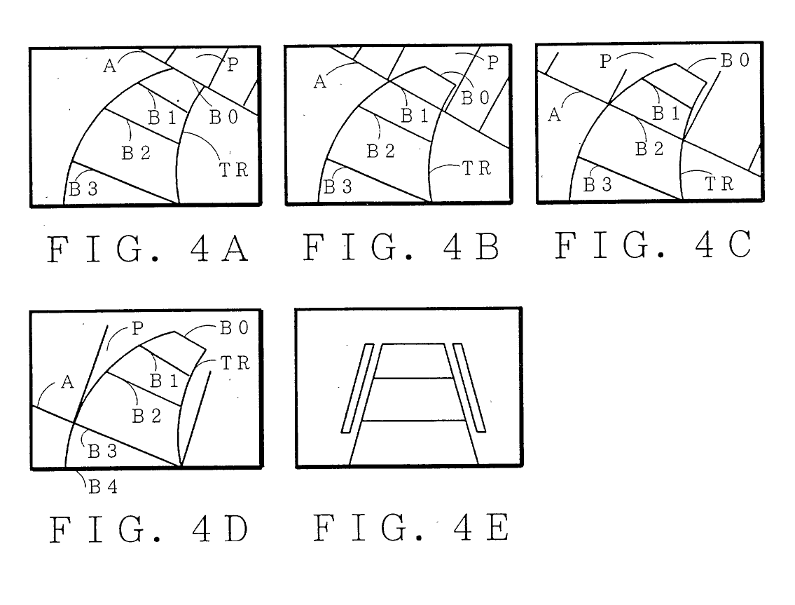

Action of the embodiment of this invention will be described with reference to a flowchart in FIG. 3 and drafts of screens in FIG. 4A, 4B, 4C, 4D and 4E.

This apparatus is started simultaneously with a build up (ON) of an ignition (IG) signal by inserting a not-shown engine key and a microcomputer M is started and memories of the microcomputer M, structuring a control portion of the apparatus is initialized (step S1). Switch signals generated by operating a rear indicating switch SW1 and a course indicating switch SW2 are inputted to the microcomputer M (step S3) and it is judged whether or not the rear indicating switch is in ON condition (step S5). When a driver has intention to park a vehicle in a parking space and the driver turns the rear indicting switch SW1 on, an image datum of a rear area view of the vehicle, based on an image signal from a camera CA, is inputted and an image of the rear area view of the vehicle is displayed on an image display device DIS (step S7, S9).

The driver turns the course indicating switch SW2 on for parking while driving the vehicle backward in low speed. When driving the vehicle backward into a parking space by right turning, the course indicating switch SW2 should be turned to A side (step S11). Thereby, an image of an intended course TR of driving a vehicle backward with the maximum steering angle to the right is displayed fixedly to superimpose on the image of the rear area view of the vehicle in the screen of the image display device DIS. The image of the intended course TR includes passing lines B0-B3 (positions to be passed by a vehicle rear edge) perpendicular to a driving course, as shown in FIGS. 4A-4D.

After the image of the intended course TR is displayed to superimpose on the image of the rear area view of the vehicle, the driver can move the vehicle to coincide a line A of a parking boundary of the parking space P in the image of the rear area view of the vehicle displayed in the screen with the passing line B0 to be passed by the vehicle in the image of the intended course TR, while the image of the rear area view of the vehicle is being inputted. The image of the intended course TR is fixed in the screen and the image of the rear area view of the vehicle moves against the image of the intended course TR in company with moving the vehicle.

When the driver ascertains to coincide the line A of the parking boundary of the parking space P with the passing line BO in the screen, as shown in FIG. 4A, the driver shall stop the vehicle at the position and put the vehicle in reverse gear and drive the vehicle backward with maintaining the maximum steering angle to the right, i.e. cutting the steering wheel fully to the right.

The vehicle is driven to approach the parking space P along the intended course TR so that the image of the parking space P by the camera CA displayed in the screen is zoomed in as shown sequentially in from FIGS. 4B to 4D and the driver can ascertain in the screen that the line A of the parking boundary approaches a passing line B4 at this side in the screen to pass through respective passing lines B1-B3 with temporary overlap.

When the driver ascertains to coincide the line A of the parking boundary with the passing line B4 in the screen, the vehicle shall be judged to reach at the rear edge to the line A of the parking boundary so that the driver returns the steering wheel to the center and drives the vehicle backward straight to the parking space P. At the time, the vehicle may move to the parking space with a driving course, not displayed in the screen, as shown in FIG. 4E. The driver shall drive the vehicle backward straight and brake the vehicle when the driver ascertain the vehicle putted in the required parking space and then turn a engine key off after put the vehicle in normal gear.

Thus, a driver can park a vehicle securely to drive the vehicle to a parking space without operating a steering wheel during driving the vehicle backward.

When the microcomputer M checks the ignition (IG) signal and the IG signal is OFF, the microcomputer M turns off displaying images (step S19, S21, S22). When the engine key is not off and the ignition (IG) signal is on, displaying images is maintained for watching rearward.

While the forms of the invention herein disclosed constitute presently preferred embodiments, many others are possible. It is not intended herein to mention all the possible embodiments of the invention which will be apparent to those skilled in the art. It is understood that the term used herein are merely descriptive rather than limiting, in that various changes may be made without departing from the spirit or scope of this invention as defined by the following claims.

What is claimed is:

1. A park-assisting apparatus comprising:
a display device for displaying an image of a predetermined rear area view of a vehicle, a relative position of which is fixed against the vehicle;
an image of intended course storing device for storing beforehand an image of an intended course in order to display the intended course of the vehicle by superimposing on the rear area view of the display device, the intended course being a course to be driven in the predetermined rear area view corresponding to the vehicle in a current position when the vehicle is driven backward with the maximum steering angle;
an image pick-up device for taking a picture of the rear area view of the vehicle; and
a superimposing display device for displaying the image of the intended course, the intended course being stored in the image of intended course storing device, by superimposing on the image of the rear area view of a vehicle being taken by the image pick-up device, upon receiving a display command from outside.

2. The park-assisting apparatus according to claim 1, wherein the image of intended course storing device stores images of intended courses of the maximum steering angle to the right and the maximum steering angle to the left and outputs one of the stored images to the superimposing display device selectively by control of a display control device in compliance with operating an image switching device.
